(19) United States
(12) Patent Application Publication
(10) Pub. No.: US 2026/0154837 A1
(43) Pub. Date: Jun. 4, 2026

(54) SYSTEMS AND METHODS FOR CALCULATING LOCAL NARROWINGS IN A DUCT TECHNICAL DOMAIN

(71) Applicant: GE Precision Healthcare LLC, Waukesha, WI (US)

(72) Inventors: Nicolas Gogin, Buc (FR); Etienne Perot, Buc (FR); Caroline Damhieu, Buc (FR); Luc Caselles, Buc (FR); Valentin Belissen, Buc (FR)

(21) Appl. No.: 19/399,036

(22) Filed: Nov. 24, 2025

(30) Foreign Application Priority Data
Nov. 29, 2024 (FR) 2413258

(51) Int. Cl. G06T 7/62; G06T 7/00; G06T 7/12

(52) U.S. Cl. CPC G06T 7/62; G06T 7/0004; G06T 7/12

(57) ABSTRACT

A system comprises a processor configured to execute the components. A data access component accesses three-dimensional image data representing at least one duct. A diameter analysis component determines a minimum diameter profile of the duct along a longitudinal axis. A window definition component defines, for each longitudinal position, a sliding examination window having known minimum diameters at longitudinal endpoints. A narrowing calculation component automatically calculates, for each position of the sliding examination window, a loss metric representing a reduction in minimum diameter relative to an interpolation of diameters at the window endpoints, the loss metric being indicative of one or more local narrowings of the duct. A boundary determination component determines, for each detected local narrowing, boundary positions corresponding to start and end locations of the narrowing based on variations in the loss metric along the duct.

### CROSS-REFERENCE TO RELATED APPLICATIONS

This application claims the benefit of priority of France Patent Application No. FR2413258, filed on Nov. 29, 2024, entitled “METHOD FOR CALCULATING LOCAL CONSTRICTIONS ON A CONDUIT.” The entirety of the aforementioned application is hereby incorporated herein by reference.

### TECHNICAL FIELD

The subject disclosure relates to image based quantitative analysis of anatomical or mechanical ducts, and more specifically to computer implemented methods and systems for automatically detecting and characterizing local narrowings of a duct, such as vascular stenoses, based on three-dimensional image data.

### BACKGROUND

Accurate evaluation of duct morphology, including changes in diameter along the length of a conduit, plays a critical role in a variety of scientific and engineering disciplines. In medical imaging, for example, analysis of vascular structures such as coronary, carotid, or renal arteries is often performed to assess the presence of stenosis, aneurysm, or other pathological variations in vessel geometry. In industrial applications, inspection of ducts, pipes, or channels is similarly important for identifying mechanical wear, deformation, or obstruction. In each of these domains, the ability to quantify a local shape and continuity of a duct provides valuable diagnostic or maintenance insight.

Conventional imaging systems can capture high resolution volumetric data representing duct structures using modalities such as computed tomography (CT), magnetic resonance imaging (MRI), or optical coherence tomography (OCT). These imaging datasets can permit visualization of the lumen and surrounding walls, enabling operators to measure cross sectional dimensions along a duct. However, determination of localized constrictions within a duct often relies on manual placement of reference markers or subjective assessment of image slices, which can vary significantly between operators and imaging sessions.

Manual analysis techniques are inherently limited in accuracy and reproducibility. Identification of a narrowing or stenosis typically depends on estimating reference diameters from adjacent regions of a duct, which introduces user dependent variability and limits comparability across studies. Moreover, manual interpretation is time consuming and can lead to inconsistent clinical or operational decisions, particularly when dealing with complex or branching duct geometries.

In recent years, algorithmic and machine learning based approaches have been developed to assist in the interpretation of duct imaging data. These systems can identify potential regions of interest, but their performance and interpretability depend on data quality, model training, or the variability of anatomical or mechanical structures. Accordingly, challenges remain using existing imaging and computational analysis methods.

### SUMMARY

The following presents a summary to provide a basic understanding of one or more embodiments. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer implemented methods, apparatus or computer program products that facilitate automated analysis of three-dimensional image data to detect and quantify local variations in duct geometry are provided. Such embodiments can employ computational processes to determine geometric parameters along a duct, evaluate local deviations relative to reference profiles, or identify regions exhibiting characteristic constrictions or reductions in cross sectional dimension.

According to one or more embodiments, a system is provided. The system can comprise a non-transitory computer readable memory that stores computer executable components and a processor that executes at least one of the computer executable components. The at least one of the computer executable components can comprise a data access component that accesses three-dimensional image data representing at least one duct. In various aspects, the at least one of the computer executable components can further comprise a diameter analysis component that determines a minimum diameter profile of the duct along a longitudinal axis of the duct. In certain implementations, the at least one of the computer executable components can further comprise a window definition component that defines, for each longitudinal position along the duct, a sliding examination window having known minimum diameters at longitudinal endpoints of the window. In some embodiments, the at least one of the computer executable components can further comprise a narrowing calculation component that automatically calculates, for each position of the sliding examination window, a loss metric representing a reduction in minimum diameter relative to an interpolation of diameters at the window's longitudinal endpoints, the loss metric being indicative of one or more local narrowings of the duct. In additional aspects, the at least one of the computer executable components can further comprise a boundary determination component that determines, for each detected local narrowing, boundary positions corresponding to start and end locations of the narrowing based on variations in the loss metric along the duct and output the boundary positions for use in at least one of visualization or a narrowing characterization output.

According to one or more embodiments, a computer implemented method is provided. In various embodiments, the computer implemented method can comprise, by a system operatively coupled to a processor, acquiring three-dimensional image data representing at least one duct. In various aspects, the computer implemented method can comprise, by the processor, determining a minimum diameter profile of the duct along a longitudinal axis of the duct. In certain embodiments, the computer implemented method can comprise, by the processor, defining, for each longitudinal position along the duct, a sliding examination window having known minimum diameters at longitudinal endpoints of the window. In some aspects, the computer implemented method can comprise, by the processor, automatically calculating, for each position of the sliding examination window, a loss metric representing a reduction in minimum diameter relative to an interpolation of diameters at the window's longitudinal endpoints, the loss metric being indicative of one or more local narrowings of the duct. In additional embodiments, the computer implemented method can comprise, by the processor, determining, for each detected local narrowing, boundary positions corresponding to start and end locations of the narrowing based on variations in the loss metric along the duct.

According to one or more embodiments, a computer program product for detecting local narrowings within a duct is provided. In various embodiments, the computer program product can comprise a non-transitory computer readable memory having program instructions embodied therewith. In various aspects, the program instructions can be executable by a processor to cause the processor to acquire three-dimensional image data representing at least one duct. In certain embodiments, the program instructions can be further executable to cause the processor to determine a minimum diameter profile of the duct along a longitudinal axis of the duct based on the three-dimensional image data. In various aspects, the program instructions can be further executable to cause the processor to define, for each longitudinal position along the duct, a sliding examination window having known minimum diameters at longitudinal endpoints of the window. In some instances, the program instructions can be further executable to cause the processor to automatically calculate, for each position of the sliding examination window, a loss metric representing a reduction in minimum diameter relative to an interpolation of diameters at the window's longitudinal endpoints, the loss metric being indicative of one or more local narrowings of the duct. In additional embodiments, the program instructions can be further executable to cause the processor to determine, for each detected local narrowing, boundary positions corresponding to start and end locations of the narrowing based on variations in the loss metric along the duct.

### DESCRIPTION OF THE DRAWINGS

FIG. 1 illustrates a block diagram of an example, non-limiting system 100 that can facilitate computer-implemented detection, quantification, and boundary determination of local narrowings within three-dimensional image data representing one or more ducts, in accordance with embodiments described herein.

FIG. 2 illustrates a block diagram of an example, non-limiting embodiment of system 200 that can facilitate computerized detection, quantification, and boundary determination of local duct narrowings from three-dimensional image data, in accordance with embodiments described herein.

FIG. 3 illustrates a flow diagram of an example, non-limiting computer-implemented method 300 that can facilitate automated detection, quantification, and boundary determination of local duct narrowings in accordance with one or more embodiments described herein.

FIG. 4A illustrates a flow diagram of an example, non-limiting portion of a computer implemented method 400 that governs image intake, segmentation, and preliminary analysis in accordance with one or more embodiments described herein.

FIG. 4B illustrates a flow diagram of an example, non-limiting narrowing characterization and visualization subprocess corresponding to act 418 of FIG. 4A, in accordance with one or more embodiments described herein.

FIG. 5 illustrates a flow diagram of an example, non-limiting computer implemented method 500 that depicts an exemplary logical sequence and conditional structure used by the system for calculating and classifying local narrowings within a duct, in accordance with one or more embodiments described herein.

FIG. 6 illustrates an example, non-limiting schematic representation of a three-dimensional duct tree 600 in accordance with one or more embodiments described herein.

FIG. 7 illustrates an example, non-limiting schematic representation of a duct segment 700 comprising a localized narrowing in accordance with one or more embodiments described herein.

FIG. 8 illustrates a block diagram of an example, non-limiting operating environment in which one or more embodiments described herein can be facilitated.

FIG. 9 illustrates an example networking environment operable to execute various implementations described herein.

### DETAILED DESCRIPTION

The following detailed description is merely illustrative and is not intended to limit embodiments or application/uses of embodiments. Furthermore, there is no intention to be bound by any expressed or implied information presented in the preceding Background or Summary sections, or in the Detailed Description section.

The analysis of duct morphology, such as blood vessels, airways, or engineered conduits, plays a fundamental role in diagnostic imaging, interventional planning, and maintenance of both physiological and mechanical systems. In medical imaging, for instance, identifying changes in the diameter of vascular structures is central to detecting pathological conditions such as stenosis, aneurysm, or occlusion. Clinicians often rely on three-dimensional imaging modalities such as computed tomography (CT), magnetic resonance imaging (MRI), or intravascular ultrasound (IVUS) to visualize these structures. In industrial contexts, similar imaging and inspection processes are used to evaluate the structural integrity of pipes, channels, or conduits that transport fluids or gases.

Despite availability of advanced imaging technologies, quantitative evaluation of local narrowings along ducts remains largely inconsistent, manual, and error prone. Conventional software tools typically allow an operator to view image slices, trace vessel centerlines, and measure cross sectional diameters at user selected points. From these isolated measurements, users estimate the extent of narrowing and its clinical or mechanical relevance. However, this approach is subjective, labor intensive, and highly sensitive to operator skill and judgment. Small variations in the selection of measurement points can lead to large differences in computed stenosis ratios or percent diameter reductions, undermining reproducibility across readers, institutions, and time.

Recent efforts to automate stenosis detection have incorporated machine learning and convolutional neural network (CNN) algorithms trained on labeled datasets of vascular images. While such methods can highlight potential areas of concern, they do not produce physically interpretable or quantitative measures of local narrowing severity. Neural network-based classification systems typically assign categorical labels, such as “normal” or “stenosed,” without providing direct geometric metrics or boundary definitions that can be clinically validated. As a result, these methods lack transparency and fail to establish standardized quantitative benchmarks. In practice, clinicians remain dependent on manual confirmation, leaving diagnostic confidence unchanged and automation gains unrealized.

Moreover, existing geometric approaches for duct analysis often rely on static thresholding or global curve fitting, which fails to capture the localized nature of true narrowings. In a blood vessel, for example, a gradual tapering of diameter near a distal region is physiologic and should not be interpreted as a stenosis. However, abrupt localized changes, potentially reflecting calcified plaque or structural occlusion, are diagnostically meaningful. Current systems are not equipped to reliably differentiate between physiologic tapering, imaging artifacts, or genuine focal constrictions. This deficiency limits both diagnostic accuracy and computational robustness.

Accordingly, systems or techniques that can address one or more of these technical problems can be desirable.

The disclosed technology addresses the foregoing limitations through an integrated computational architecture that performs automated, quantitative analysis of duct morphology using three-dimensional image data acquired by physical imaging systems. In various embodiments, the system includes one or more processors configured to execute stored program instructions that access volumetric image data representing a duct (such as a vascular structure, airway, or mechanical conduit) and process that data to extract reliable geometric parameters describing local cross-sectional variations. The system thereby provides an improvement in computer implemented image processing, enabling reproducible or objective quantification of localized constrictions without requiring user dependent reference points or manual measurement.

In various embodiments, the disclosed system can establish a minimum diameter profile along a longitudinal axis of a duct by segmenting a volumetric image and determining, at discrete intervals, a smallest lumen diameter within each cross-sectional plane orthogonal to a duct's centerline. This profile data is not an abstract mathematical construct, but rather a data structure generated from pixel or voxel level intensity information derived directly from an imaging modality. By grounding each computational step in image derived data, the system can operate as a specialized image analysis machine that transforms raw medical or structural imaging data into quantifiable, physically interpretable metrics.

According to some embodiments, once a diameter profile is established, the processor can define a sequence of sliding examination windows along a duct, each window corresponding to a contiguous range of longitudinal positions having known minimum diameters at its endpoints. Within each window, the processor can compute a loss metric, a numeric measure representing a reduction in local minimum diameter relative to an interpolated baseline between a window's endpoints. Unlike generalized curve fitting techniques or statistical inference models, this loss metric can reflect a physically constrained geometric comparison that captures true localized narrowing while discounting gradual physiological tapering or imaging noise. By repeating this computation across a set of dynamically positioned windows, the system can generate a loss metric profile that represents a continuous, data driven description of diameter variation along a duct.

In various embodiments, from a loss metric profile, the system can identify locations at which a loss metric exceeds one or more predetermined thresholds, automatically detecting one or more regions corresponding to local narrowings. The processor then can determine boundary positions for each detected narrowing by analyzing gradients and local extrema of a loss metric profile, thereby delineating start and end points of each constriction. These boundary determinations can be based on reproducible mathematical relationships between measured diameters and interpolated baselines, rather than on subjective user input. As a result, the system can produce machine determined narrowing boundaries that align with true physiological or mechanical features observable in underlying image data.

Importantly, the disclosed framework can be implemented using specialized computer components and data structures that can improve functioning of imaging analysis systems themselves. For example, the system can employ optimized sampling intervals, adaptive sliding window definitions, or multi-scale window sets that improve computational efficiency or resolution. By performing calculations on preprocessed three-dimensional image data, the system can reduce noise sensitivity, minimizes false positives from vessel bifurcations, or increases accuracy of stenosis detection. These improvements represent specific enhancements to operation of image processing computers, not a mere automation of a mental process or manual diagnostic procedure.

In certain embodiments, the system records positional and quantitative attributes of detected narrowings in a structured digital format that can be used for visualization, longitudinal comparison, or integration with electronic health records or maintenance databases. In some embodiments, visualization modules can render a three-dimensional reconstruction of a duct overlaid with color coded constriction regions, thereby providing intuitive, quantitative insight for clinical or engineering users. Combination of automated detection, quantification, and visualization within a single computational workflow can enable consistent, high confidence evaluation of duct morphology across users, imaging modalities, or time points.

Accordingly, the disclosed technology provides a concrete and technological improvement over prior image analysis methods, both by transforming raw volumetric imaging data into actionable quantitative information and by improving efficiency or reproducibility of computer-based duct analysis. It thereby bridges the gap between qualitative visualization and objective, machine verified measurement, producing consistent, interpretable, or physically meaningful results unattainable through conventional manual or artificial intelligence (AI) based techniques.

The following paragraphs describe exemplary embodiments of the disclosed system and its operation in greater technical detail. These embodiments illustrate specific implementations of the computational framework introduced above and demonstrate how various system components interact to acquire image data, derive geometric measurements, calculate loss metrics, or determine narrowing boundaries. The described embodiments are provided by way of example and that functional elements can be implemented in software, hardware, firmware, or any suitable combination thereof. Additional modifications, rearrangements, or equivalent substitutions can be made without departing from the scope of the inventive concepts disclosed herein.

In one embodiment, a system configured in accordance with the present disclosure includes one or more processors operatively coupled to a non-transitory computer readable memory storing computer executable components. The processor can be implemented using general purpose central processing units (CPUs), graphics processing units (GPUs), or dedicated image processing hardware. The system can operate as part of an imaging workstation, a cloud-based analysis platform, or an embedded module integrated into an imaging modality such as a computed tomography (CT) or magnetic resonance imaging (MRI) scanner.

Various embodiments described herein can be considered as a computerized tool (i.e., any suitable combination of computer executable hardware and computer executable software) configured to facilitate automated detection, quantification, or boundary determination of local narrowings within three-dimensional image data representing one or more ducts. In certain aspects, such computerized tools can comprise a data access component configured to access or receive three dimensional image data of at least one duct, a diameter analysis component that determines a minimum diameter profile of a duct along a longitudinal axis based on lumen geometry derived from image data, a window definition component that defines, for each longitudinal position along a duct, one or more sliding examination windows having known minimum diameters at respective longitudinal endpoints, a narrowing calculation component that automatically calculates, for each window, a loss metric representing a reduction in minimum diameter relative to an interpolation of diameters at a window's endpoints, a loss metric being indicative of one or more local narrowings of a duct, and a boundary determination component that determines, for each detected local narrowing, boundary positions corresponding to start and end locations of the narrowing based on variations in the loss metric along the duct and output the boundary positions for use in at least one of visualization or a narrowing characterization output.

In some embodiments, the system can further include components such as a recording component that records positions of sliding windows for which a loss metric exceeds a threshold value indicative of a narrowing, an overlap resolution component that evaluates overlapping windows, compute average loss metrics, and select representative windows corresponding to unique narrowing events, an image segmentation component that segments image data representing a duct tree into individual branches and to enable a diameter analysis and narrowing calculation components to operate on each branch independently, and a visualization component that generates display data depicting regions of a duct having loss metrics above threshold values and highlighting boundary positions of each detected narrowing. Each of the foregoing components can operate independently or cooperatively within a unified computational workflow implemented in any suitable combination of hardware, software, or firmware consistent with the claimed relationships among components.

In one embodiment, the data access component can obtain volumetric image data representing at least one duct from an imaging modality. Imaging modality can include, without limitation, computed tomography (CT), magnetic resonance imaging (MRI), optical coherence tomography (OCT), intravascular ultrasound (IVUS), angiography, or any other imaging system capable of acquiring three-dimensional volumetric data. In some embodiments, image data can be acquired directly by the system through a communication interface with an imaging modality. In other embodiments, image data can be retrieved from a local or remote database, a cloud repository, or an electronic health record system. Accessed data can represent either a single duct or a network of ducts (i.e., a duct tree) that includes multiple branches, bifurcations, or segments.

In certain embodiments, an image segmentation component can preprocess volumetric image data to isolate a lumen or interior of a duct from surrounding structures. Segmentation can be performed using thresholding, region growing algorithms, active contour models, or machine learning segmentation networks that can detect a lumen based on intensity gradients, texture features, or probability maps. The segmentation component can produce a binary or probabilistic mask identifying lumen voxels, from which a three-dimensional model of a duct geometry can be reconstructed. In embodiments where image data represents a duct tree, the segmentation component can separate individual branches such that subsequent analysis is performed on each branch independently.

Once segmentation is completed, a diameter analysis component can determine a minimum diameter profile of a duct along its longitudinal axis. The diameter analysis component can compute a centerline through a duct lumen using skeletonization or medial axis algorithms. Orthogonal cross-sectional planes can be generated at discrete longitudinal intervals along a centerline (i.e., between approximately 0.1 millimeter and 1.0 millimeter, preferably between 0.2 millimeter and 0.5 millimeter, and even more preferably around 0.3 millimeter). For each cross section, the diameter analysis component can compute a smallest inscribed circle or equivalent radius within a lumen boundary, thus determining a local minimum diameter value D(x). A resulting collection of diameter values along a longitudinal axis constitutes a minimum diameter profile representing a duct's internal cross-sectional dimension as a function of longitudinal position.

In some embodiments, the diameter analysis component can apply a condition that restricts computation to regions of a duct having minimum diameters greater than a predetermined threshold (i.e., between 1.0 millimeters and 3.0 millimeters, preferably between 1.5 millimeters and 2.0 millimeters, and even more preferably approximately 1.6 millimeters). This condition can exclude distal regions of a vessel or conduit where natural taper results in small diameters that could generate unreliable metrics. By applying this condition, a system improves computational stability and avoids false positive detection of non-pathologic narrowing events in physiologically small segments.

Once a minimum diameter profile is determined, a window definition component can define one or more sliding examination windows along a duct. Each sliding examination window can be defined as a contiguous longitudinal interval bounded by two endpoints (x₁ and x₂) corresponding to positions along a duct for which minimum diameters D(x₁) and D(x₂)are known. Distance between endpoints defines a window width, which can range between 1.8 millimeters and 14.1 millimeters. In some embodiments, a plurality of sliding examination windows can be defined as having distinct longitudinal spans to enable multi scale analysis of duct geometry. The window definition component can advance a sliding window along a longitudinal axis in increments corresponding to a sampling interval of a minimum diameter profile.

In operation, for each position of a sliding examination window, the window definition component can interpolate a baseline diameter curve between minimum diameters measured at longitudinal endpoints of a window. Interpolation can be linear, polynomial, spline based, or performed using a regression model selected to best approximate expected baseline geometry. Interpolated curve represents a theoretical lumen diameter distribution that would be expected if no narrowing were present.

A narrowing calculation component can then compute a loss metric that represents a reduction in a minimum diameter within each sliding examination window relative to an interpolated baseline. For each longitudinal position x within a window, the narrowing calculation component can compute a deviation ΔD(x)=Dᵢ(x)−D(x), where Dᵢ(x) is an interpolated baseline diameter and D(x) is a measured diameter. A maximum of deviation values within a window, or alternatively an average of deviations, can be used to define a loss metric for that window. Computed loss metric can be stored together with window position and width.

As a sliding examination window advances along a duct, the system can compute and store loss metrics for successive window positions, thereby producing a loss metric profile that describes local variations in a duct's cross-sectional dimension. In some embodiments, a loss metric profile can be analyzed to detect one or more local peaks corresponding to abrupt decreases in diameter, which indicate potential narrowing events. Peaks can be identified through gradient based detection, peak finding algorithms, or other signal processing techniques configured to identify local maxima in a loss metric profile.

In some embodiments, the narrowing calculation component can further apply a filter condition requiring that a computed loss metric exceed a relative percentage of the smaller of the endpoint diameters (i.e., approximately 40 percent). This additional filtering step can exclude regions where apparent constrictions result from normal tapering or branching of a duct rather than from pathological or structural narrowings. Application of this filter improves specificity by ensuring that only focal, abnormal constrictions are classified as detected narrowing events.

A recording component can record a position or parameters of any sliding window for which a loss metric exceeds a threshold value indicative of a local narrowing. A threshold value can be fixed (e.g., 50 percent or 70 percent loss relative to baseline) or dynamically determined based on an average minimum diameter of adjacent duct segments. A recording component can store a position, window width, endpoint diameters, or loss metric values in memory for subsequent refinement and classification.

When multiple recorded windows overlap in position, an overlap resolution component can evaluate overlapping windows to identify a representative window corresponding to a unique narrowing event. In some embodiments, the overlap resolution component can compute an average loss metric within each overlapping window and select a window exhibiting a greatest average loss as the representative. This can ensure that each physical narrowing is detected and classified once, thereby avoiding redundant detections.

A boundary determination component can then determine, for each detected local narrowing, boundary positions corresponding to start and end locations of the narrowing based on variations in the loss metric along the duct and output the boundary positions for use in at least one of visualization or a narrowing characterization output. In various embodiments, the boundary determination component can analyze gradients or local extrema of a loss metric profile to identify boundary coordinates corresponding to a start and end of a narrowing. These boundary positions can be stored as longitudinal coordinates and can represent physiologic or mechanical limits of each detected constriction.

In certain embodiments, a visualization component can generate display data that depicts detected narrowings within a graphical representation of a duct. The visualization component can render a three-dimensional reconstruction of a duct, overlaying color-coded regions corresponding to computed loss metrics. Visualization can highlight start or end boundaries of each narrowing and can display quantitative information such as maximum loss percentage, average loss, or narrowing length. The visualization component can output display data to a graphical user interface, export to an electronic record system, or store results in a digital database for longitudinal analysis.

In some embodiments, the window definition component can define a plurality of sliding examination windows having distinct longitudinal spans to enable a multi scale analysis of duct geometry. By varying a window width from small to large values (e.g., between 1.8 millimeters and 14.1 millimeters), the system can simultaneously detect short, sharp constrictions or longer, diffuse narrowing regions. The narrowing calculation component can execute across multiple window widths in parallel, producing a multi resolution loss metric profile that provides comprehensive characterization of duct morphology.

The system can also operate iteratively across multiple ducts or branches of a duct tree. The segmentation component can isolate each branch, and the diameter analysis, window definition, and narrowing calculation components can operate independently on each branch. This configuration can enable scalable processing of complex duct networks and can allow independent characterization of each duct segment.

The system can record all analytical outputs in structured digital format, including for each narrowing event its start and end positions, window width, maximum and average loss metrics, threshold values, and corresponding confidence levels. These records can be used for longitudinal comparison, progression monitoring, or statistical analysis across a population of ducts or patients.

In another embodiment, the disclosed technology can be implemented as a computer implemented method that includes acquiring three dimensional image data representing at least one duct, determining a minimum diameter profile along a longitudinal axis of a duct, defining sliding examination windows, calculating a loss metric for each window, identifying local narrowings where a loss metric exceeds a threshold, determining boundary positions corresponding to a start or end of each detected narrowing, or generating quantitative or visual representations of results. The method can further include recording and storing narrowing data, resolving overlapping detections, applying filters to exclude tapering regions, or dynamically determining threshold values based on local geometric averages.

In still another embodiment, the disclosed technology can be realized as a computer program product comprising a non-transitory computer readable medium having program instructions embodied thereon. When executed by one or more processors, the program instructions can cause the processors to perform operations corresponding to the computer implemented method. The computer program product can be distributed in tangible form or electronically via a network and can operate as part of an imaging analysis suite or as a standalone application executed by a workstation or cloud computing environment.

Embodiments of the disclosed invention provide significant technical improvements to image-based duct analysis. The disclosed system automates detection and quantification of local narrowings, eliminates operator dependency, and enhances reproducibility. Use of sliding window interpolation and computed loss metrics can enable a physically grounded, data driven approach to constriction identification, improving diagnostic accuracy and computational robustness. The system thereby can transform raw imaging data into structured, quantitative information suitable for downstream diagnostic, engineering, or maintenance applications.

Although the disclosed embodiments are described primarily in the context of physiological ducts such as coronary arteries, carotid arteries, renal arteries, or bile ducts, the same methods and system architecture can be applied to industrial conduits, pipelines, and other tubular structures for detecting corrosion, occlusions, or deformations. Various modifications and alternative configurations consistent with the described framework will be apparent to those skilled in the art and are intended to fall within the scope of the appended claims.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

It should be appreciated that the figures and description herein provide non-limiting examples of various embodiments and are not necessarily drawn to scale.

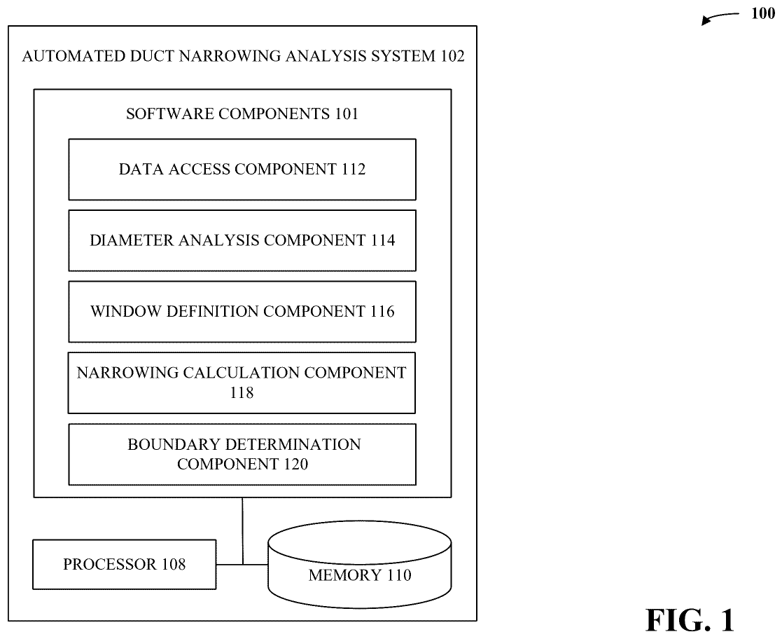

FIG. 1 illustrates a block diagram of an example, non-limiting system 100 that can facilitate computer-implemented detection, quantification, and boundary determination of local narrowings within three-dimensional image data representing one or more ducts, in accordance with embodiments described herein. In various embodiments, Automated Duct Narrowing Analysis System 102 can comprise a processor 108 (i.e., one or more central processing units (CPUs), graphics processing units (GPUs), or other specialized image-processing accelerators) and a non-transitory computer-readable memory 110 operatively or communicatively coupled to processor 108. Memory 110 can store a set of software components 101, each implemented as computer-executable instructions, where software components 101 can include data access component 112, diameter analysis component 114, window definition component 116, narrowing calculation component 118, and boundary determination component 120. Upon execution, these components cause processor 108 or other elements of Automated Duct Narrowing Analysis System 102 to perform acts related to volumetric image acquisition, duct segmentation, geometric measurement, loss metric computation, or automatic boundary determination. In some embodiments, memory 110 can further store intermediate geometric profiles, loss metric tables, configuration parameters, or visualization data that enable processor 108 to execute a complete image-analysis workflow.

In various embodiments, data access component 112 can obtain or receive three-dimensional image data representing at least one duct. In some embodiments, data access component 112 can communicate directly with an imaging modality (i.e., computed tomography (CT), magnetic resonance imaging (MRI), optical coherence tomography (OCT), or angiography) or retrieve previously acquired image volumes from a local or remote database. According to various embodiments, data access component 112 can also manage preprocessing operations such as file decoding, voxel normalization, and coordinate registration to ensure compatibility between image datasets and subsequent computational components.

In various embodiments, diameter analysis component 114 can determine a minimum diameter profile of a duct along a longitudinal axis. For some embodiments, diameter analysis component 114 can segment a duct lumen, compute a geometric centerline, and generate orthogonal cross-sections at discrete longitudinal intervals (i.e., from about 0.1 mm to 1 mm, preferably 0.3 mm). For each cross-section, diameter analysis component 114 can calculate a smallest inscribed circle or equivalent diameter within a lumen boundary, thereby defining a sequence of minimum diameter measurements that collectively represent a duct's internal profile. In some embodiments, diameter analysis component 114 can exclude sections whose minimum diameters fall below a threshold (i.e., 1.5-2.0 mm) to minimize noise sensitivity and restrict analysis to physiologically or structurally relevant regions.

In one or more embodiments, window definition component 116 can define, for each longitudinal position along a duct, one or more sliding examination windows having known minimum diameters at respective longitudinal endpoints. Longitudinal endpoints can be separated by a distance ranging from approximately 1.8 millimeters to 14.1 millimeters. In some embodiments, window definition component 116 can advance each sliding examination window in increments corresponding to a sampling interval of a minimum diameter profile and can interpolate a baseline diameter curve between endpoint diameters. In certain embodiments, interpolation can be linear, polynomial, spline-based, or implemented using a regression model selected according to desired accuracy or computational complexity. In further embodiments, multiple window spans can be defined to enable multi-scale analysis of local diameter variations along the duct, allowing the system to identify both short focal constrictions and longer diffuse narrowings.

In some embodiments, narrowing calculation component 118 can automatically calculate, for each position of a sliding examination window, a loss metric representing a reduction in the measured minimum diameter relative to the interpolated baseline. For each longitudinal position x within a window, the processor can compute a loss metric according to a relationship ΔD(x)=Dinterp(x)−D(x), where Dinterp(x) is an interpolated baseline diameter between endpoint diameters D(x₁) and D(x₂) and D(x) is the measured minimum diameter at that longitudinal position. A maximum or average value of ΔD(x) within a window defines the loss metric for that window. In one embodiment, for each sampled position within a window, narrowing calculation component 118 can determine a deviation between an interpolated baseline diameter and a measured diameter and compute either a maximum or an average of these deviations to define the loss metric for that window. In certain embodiments, as sliding examination windows progress along the duct, narrowing calculation component 118 can compile a continuous loss metric profile that quantitatively describes localized constrictions. In yet other embodiments, peaks within the loss metric profile can correspond to potential narrowing events, and narrowing calculation component 118 can apply a filter requiring that the computed loss metric exceed a relative percentage (i.e., approximately 40%) of a smaller endpoint diameter, thereby excluding tapering or bifurcation zones that would otherwise generate false positives.

In some embodiments, boundary determination component 120 can determine, for each detected local narrowing, boundary positions corresponding to start and end locations of a narrowing based on spatial variations of the loss metric profile. As used herein, “optimal boundary positions” or “boundary positions” refer to longitudinal coordinates at which a first derivative (gradient) of a loss metric profile exhibits local extrema adjacent to a peak loss region. In practice, these positions correspond to inflection points or turning points of a loss metric curve that mark a transition between normal lumen diameter and a narrowed region. The processor can identify these extrema using gradient analysis, curve-fitting, or equivalent numerical methods to generate reproducible start and end boundary coordinates for each narrowing. In certain embodiments, boundary determination component 120 can identify local extrema or inflection points of the loss metric curve adjacent to each peak loss region and record those coordinates as boundary markers. In one or more embodiments, the boundary determination component 120 can output quantitative data such as narrowing length, maximum loss percentage, and boundary coordinates to memory 110 for further visualization or reporting. In still further embodiments, boundary determination component 120 can implement dynamic smoothing, gradient-based segmentation, or adaptive thresholding to refine detected boundary locations and ensure alignment with anatomical or structural features visible in the underlying imaging data.

In various embodiments, Automated Duct Narrowing Analysis System 102 can further include optional modules that enhance automation, accuracy, and interpretability of the analytical workflow. In one embodiment, a recording component can record positions of sliding windows for which loss metrics exceed predefined or dynamically determined threshold values (i.e., 50% or 70% reduction relative to baseline) and can store window attributes and parameters for subsequent review. In some embodiments, an overlap resolution component can evaluate overlapping recorded windows, compute average loss metrics, and select representative windows corresponding to unique narrowing events, thereby identifying distinct constrictions, and refining the boundary positions determined by boundary determination component 120. In certain embodiments, a visualization component can generate display data depicting regions of the duct having loss metrics above threshold values and highlighting the corresponding boundaries using color-coded overlays within three-dimensional reconstructions of the duct. Each optional module can, in some embodiments, interact with processor 108 and memory 110 through standardized data structures and execution threads, enabling modular integration, scalability, and high-performance parallel processing across multiple image datasets.

In certain embodiments, Automated Duct Narrowing Analysis System 102 can be implemented within a cloud-based or distributed computing infrastructure. In some embodiments, processor 108 can execute computationally intensive tasks (i.e., diameter profiling, loss metric computation, or boundary determination) using graphics processing unit (GPU) accelerated instances or parallelized compute nodes, while memory 110 can maintain synchronized datasets through shared or networked storage. In further embodiments, Automated Duct Narrowing Analysis System 102 can operate as a standalone diagnostic workstation, an embedded module within an imaging scanner, or a remotely accessible analysis service integrated into an enterprise imaging environment. In other embodiments, coordinated execution of the data access, diameter analysis, window definition, narrowing calculation, and boundary determination components can provide end-to-end, automated detection, quantification, or boundary identification of duct narrowings with improved reproducibility, computational efficiency, or interpretability across diverse imaging modalities and deployment environments.

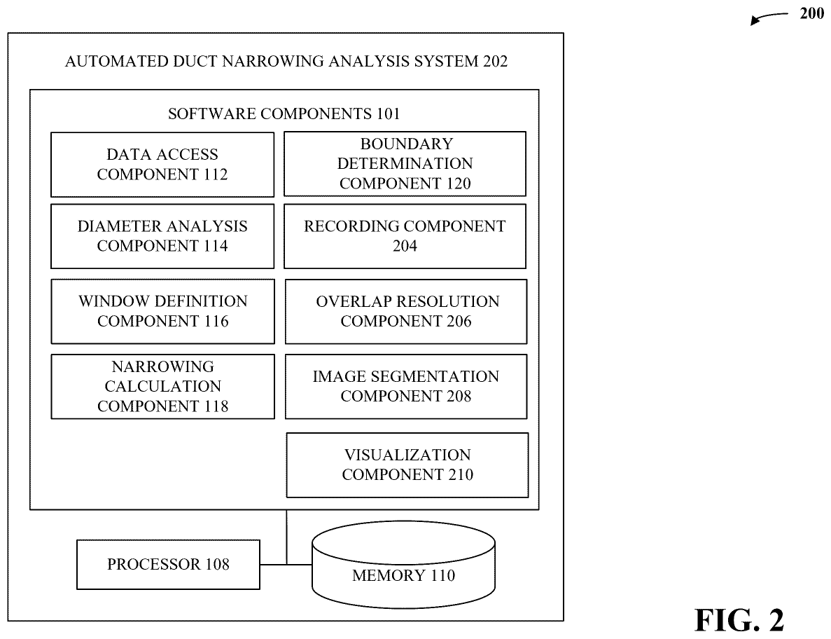

FIG. 2 illustrates a block diagram of an example, non-limiting embodiment of system 200 that can facilitate computerized detection, quantification, and boundary determination of local duct narrowings from three-dimensional image data, in accordance with embodiments described herein. In various embodiments, Automated Duct Narrowing Analysis System 202 can implement a set of software components 101 stored in memory 110 and executed by processor 108, where the software components 101 include data access component 112, diameter analysis component 114, window definition component 116, narrowing calculation component 118, and boundary determination component 120. For the sake of brevity, elements and functions previously described in connection with FIG. 1 are not repeated, except where necessary to explain additional structures or operational relationships. System 200 can further include other components such as a recording component 204, an overlap resolution component 206, an image segmentation component 208, and a visualization component 210. In certain embodiments, these additional components can be selectively invoked before, during, or after operation of the core analysis pipeline to enhance reproducibility, diagnostic interpretability, computational efficiency, or visualization of the resulting analysis.

In one or more embodiments, recording component 204 can record positional and quantitative information associated with one or more sliding examination windows for which a loss metric exceeds a predetermined or dynamically determined threshold value indicative of a local narrowing. Recorded data can include, for example, window positions, endpoint diameters, window widths, local loss metrics, and associated timestamps. In some embodiments, recording component 204 can store this information in a structured format within memory 110 or in a distributed database for subsequent review, longitudinal comparison, or integration with downstream diagnostic systems. In certain embodiments, recording component 204 can also annotate data with contextual metadata such as imaging modality, acquisition parameters, or patient or conduit identifiers, thereby supporting auditability and reproducibility of computational results across imaging sessions and hardware configurations.

In various embodiments, overlap resolution component 206 can analyze recorded windows that overlap in longitudinal position to identify a representative window corresponding to each distinct narrowing event. Overlap resolution component 206 can compute average or weighted loss metrics across overlapping regions and select, as a representative, a window exhibiting a highest average loss or satisfying a predefined confidence criterion. In some embodiments, overlap resolution component 206 can iteratively merge partially overlapping windows to generate a consolidated set of non-redundant narrowing events. In further embodiments, overlap resolution component 206 can communicate with boundary determination component 120 to adjust or refine the start and end coordinates of the narrowing boundaries based on the representative window's position. Through these operations, overlap resolution component 206 can ensure that each physical constriction is represented once, eliminating redundant detections and enhancing consistency across computational runs.

In certain embodiments, image segmentation component 208 can isolate individual ducts or branches from the three-dimensional image data prior to analysis. Component 208 can implement thresholding, active contour modeling, region growing, morphological filtering, or neural network-based segmentation techniques to delineate lumen boundaries. In some embodiments, when image data represent a duct tree, image segmentation component 208 can automatically separate a tree into individual branches and invoke diameter analysis component 114 and narrowing calculation component 118 on each branch independently. In further embodiments, segmentation can be guided by a priori anatomical templates, lumen centerline tracking, or probabilistic models to ensure anatomical plausibility and reduce segmentation leakage. Resulting segmented branches can then be processed in parallel, improving computational throughput and enabling large-scale analysis across complex networks of ducts or vessels.

In some embodiments, visualization component 210 can generate display data that visually depict regions of the duct having loss metrics above threshold values and highlight corresponding boundary positions determined by boundary determination component 120. Visualization component 210 can produce two-dimensional or three-dimensional renderings of the duct, optionally overlaid with color-coded intensity maps representing magnitude of a loss metric. In certain embodiments, visualization component 210 can also generate quantitative annotation overlays, graphical indicators of narrowing severity, or textual labels identifying maximum loss percentage and narrowing length. In further embodiments, visualization component 210 can export visual data to a user interface, diagnostic workstation, or networked reporting system, enabling clinical or engineering users to review detected constrictions in an interpretable and reproducible manner. Visualization component 210 can employ standard image-rendering libraries, graphics processing unit (GPU) accelerated pipelines, or web-based visualization frameworks to ensure responsive and scalable interaction with volumetric datasets.

In some embodiments, the system can further generate clinically relevant scores or alerts based on quantified narrowing parameters or boundary positions. For example, the system can compute a stenosis severity classification such as a coronary artery disease reporting and data system (CAD-RADS) score or other standardized coronary reporting metric derived from a maximum loss value, average loss value, or computed narrowing length. In certain embodiments, the system can automatically annotate start and end boundary coordinates within a graphical user interface, provide an alert when narrowing severity exceeds a predetermined threshold, or display recommended follow-up actions based on a computed classification. Outputs can assist clinical users by presenting quantitative, interpretable indicators derived from automated narrowing analysis and integrating results directly into diagnostic workflows.

In various embodiments, Automated Duct Narrowing Analysis System 202 can orchestrate operation of components 112-120 and 204-210 under a policy driven or event driven architecture. For instance, a representative workflow can include image segmentation (208)→data access (112)→diameter analysis (114)→window definition (116)→narrowing calculation (118)→recording (204)→overlap resolution (206)→boundary determination (120)→visualization (210). In some embodiments, the sequence of operations can be dynamically modified according to imaging modality, dataset size, or user specified objectives. For example, the system can bypass segmentation when pre-segmented masks are available or can execute overlap resolution concurrently with boundary determination to accelerate throughput. In certain embodiments, configuration parameters governing window spacing, loss metric thresholds, or visualization color scales can be stored in memory 110 and retrieved by processor 108 at runtime to ensure consistent processing across analysis sessions.

In further embodiments, Automated Duct Narrowing Analysis System 202 can be implemented using a cloud based or hybrid computing architecture that enables distributed execution of computationally intensive tasks such as loss metric computation or segmentation. Processor 108 can schedule operations across GPU accelerated instances, while memory 110 maintains synchronized copies of volumetric data, profiles, and analysis outputs. In some embodiments, system 200 can operate as a standalone workstation, an embedded analysis engine within an imaging scanner, or a remotely accessible service connected to an enterprise imaging infrastructure. In yet other embodiments, integration of recording component 204, overlap resolution component 206, image segmentation component 208, and visualization component 210 with the core analytical components 112-120 can yield a unified, end-to-end platform that provides automated, quantitative, or interpretable characterization of duct narrowings across diverse imaging modalities and computational environments.

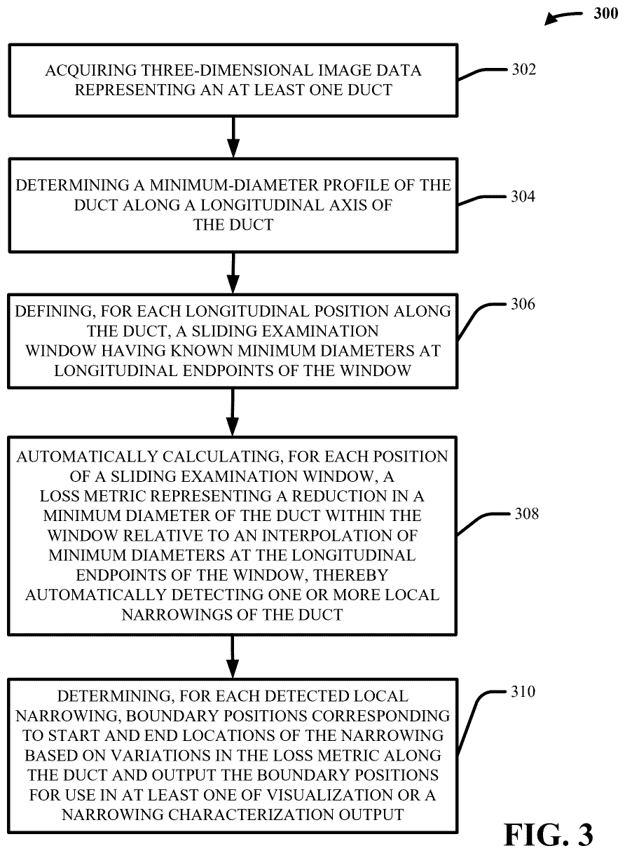

FIG. 3 illustrates a flow diagram of an example, non-limiting computer-implemented method 300 that can facilitate automated detection, quantification, and boundary determination of local duct narrowings, in accordance with one or more embodiments described herein. In various embodiments, computer-implemented method 300 can be executed by a device or system (e.g., Automated Duct Narrowing Analysis System 102 or 202) comprising at least one processor 108 operatively coupled to a non-transitory computer-readable memory 110 storing instructions and executable components (e.g., data access component 112, diameter analysis component 114, window definition component 116, narrowing calculation component 118, and boundary determination component 120). For the sake of brevity, elements previously described with respect to FIGS. 1-2 are not repeated here, except where necessary to explain the operation of method 300.

In some embodiments, act 302 can include acquiring, by a device (for example, via data access component 112), three-dimensional image data representing at least one duct. Image data can be acquired directly from a medical or industrial imaging modality (for example, computed tomography (CT), magnetic resonance imaging (MRI), optical coherence tomography (OCT), or ultrasound) or retrieved from a local or networked storage system. Act 302 can include reading associated metadata (for example, voxel dimensions, modality type, or scan parameters), converting imaging data to a standardized volumetric format, and optionally performing intensity normalization or bias correction. In certain embodiments, acquired image data can represent a single duct or a duct tree comprising multiple branches, each of which can subsequently be analyzed independently or in parallel.

In various embodiments, act 304 can include determining, by a device (for example, via diameter analysis component 114), a minimum diameter profile of the duct along a longitudinal axis. Act 304 can include segmenting a duct lumen, identifying its centerline using medial axis or skeletonization algorithms, and generating orthogonal cross-sectional planes at discrete longitudinal intervals (for example, between 0.1 millimeter and 1.0 millimeter, preferably 0.3 millimeter). For each cross-section, a smallest inscribed circle or equivalent lumen diameter can be determined and stored as a function of longitudinal position. In certain embodiments, act 304 can exclude portions of a duct having minimum diameters below a threshold (for example, 1.5 to 2.0 millimeters) to avoid processing regions where noise or physiological tapering would confound measurements. A resulting profile can be stored in memory 110 as a geometric data structure linking each sampled position to its corresponding minimum diameter.

In some embodiments, act 306 can include defining, by a device (for example, via window definition component 116), one or more sliding examination windows along a longitudinal axis of a duct. Each window can be defined by longitudinal endpoints (x₁,x₂) having known minimum diameters D(x₁) and D(x₂). Distance between endpoints can range, for example, from about 1.8 millimeters to 14.1 millimeters, and windows can advance in increments corresponding to a sampling interval established in act 304. In certain embodiments, act 306 can include interpolating, for each window, a baseline diameter curve between endpoint diameters using linear, polynomial, or spline interpolation, thereby establishing an expected diameter distribution along the window in the absence of constriction. Multiple window spans can be analyzed in parallel to perform multi-scale assessment of duct geometry.

In various embodiments, act 308 can include automatically calculating, by a device (for example, via narrowing calculation component 118), for each position of a sliding examination window, a loss metric representing a reduction in a minimum diameter of a duct within a window relative to an interpolated baseline. For each longitudinal position x within a window, narrowing calculation component 118 can determine a deviation between an interpolated baseline diameter and a measured diameter, and can define a loss metric as either the maximum or average of such deviations. In certain embodiments, act 308 can further include filtering results such that only loss metrics exceeding a relative percentage (for example, 40 percent) of the smaller of the endpoint diameters are retained, thereby excluding tapering or bifurcation regions. Processor 108 can iteratively execute act 308 across successive windows to generate a continuous loss metric profile, which can highlight localized peaks indicative of potential narrowings.

In certain embodiments, act 310 can include determining, by a device (for example, via boundary determination component 120), boundary positions corresponding to a start and an end location of each detected local narrowing based on spatial variations in a loss metric profile. Boundary determination component 120 can identify local extrema, inflection points, or gradient transitions adjacent to each loss metric peak to delineate the longitudinal limits of the narrowing. In some embodiments, act 310 can further include storing boundary coordinates, associated loss metrics, and narrowing lengths in memory 110, and generating a quantitative record of detected constriction events. Resulting data can be visualized, analyzed, or exported to clinical or engineering systems for review.

In various embodiments, one or more of acts 302 through 310 can be performed sequentially, in parallel, or iteratively, depending on imaging modality, data volume, or processing configuration. The method can be executed locally on a workstation, remotely via a cloud computing infrastructure, or within an embedded analysis module integrated into an imaging system. In certain embodiments, intermediate data structures (for example, diameter profiles, window definitions, and loss metric arrays) can be persisted in memory 110 for auditability and reproducibility. The acts of method 300 can be implemented in software, hardware, firmware, or any suitable combination thereof, and unless stated otherwise, can be performed in the illustrated order, in an alternative order, or with one or more acts performed iteratively or concurrently.

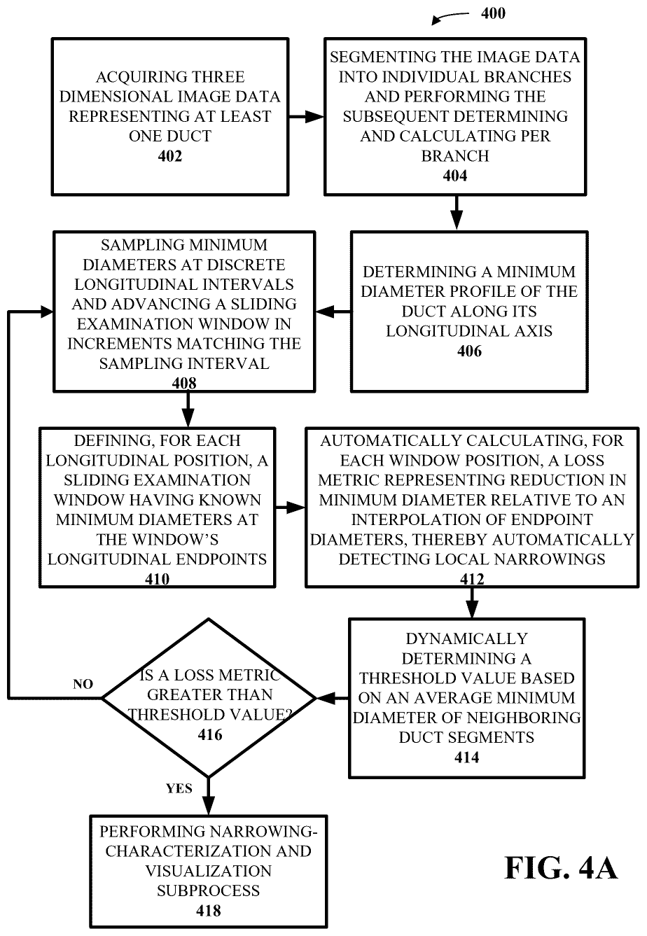

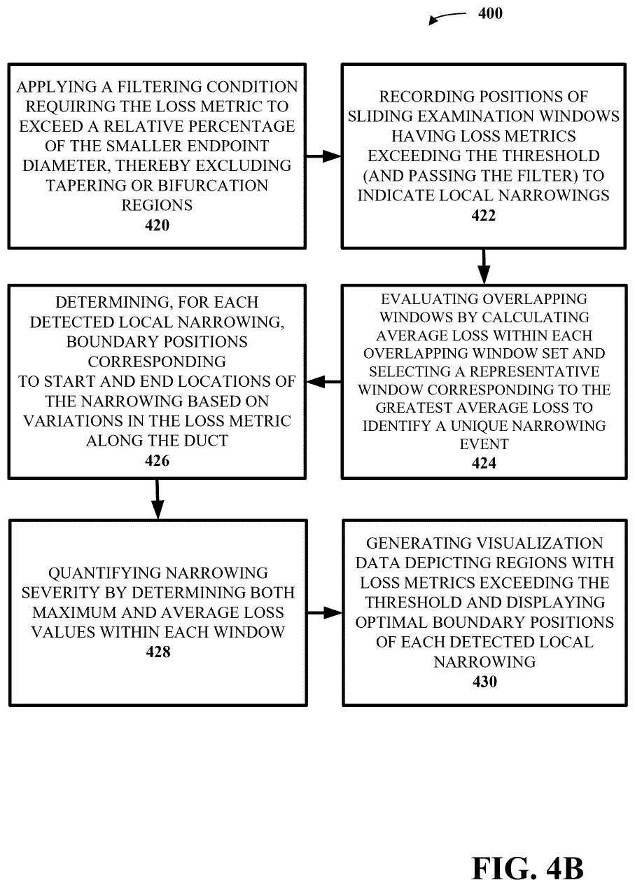

FIG. 4A illustrates a flow diagram of an example, non-limiting portion of a computer implemented method 400 that governs image intake, segmentation, and preliminary analysis in accordance with one or more embodiments described herein. Method 400 can be executed by a device or system (for example, Automated Duct Narrowing Analysis System 102 or 202) comprising at least one processor 108 operatively coupled to a non-transitory computer readable memory 110 storing executable components (for example, data access component 112, diameter analysis component 114, window definition component 116, narrowing calculation component 118, boundary determination component 120, recording component 204, overlap resolution component 206, image segmentation component 208, and visualization component 210). Repeated descriptions of like elements from preceding figures have been omitted for brevity.

In various embodiments, act 402 can include acquiring, by a device (for example, via data access component 112), three-dimensional image data representing at least one duct. Act 402 can further include retrieving associated acquisition metadata such as modality type, voxel spacing, reconstruction kernel, bit depth, or coordinate orientation, and staging the data within memory 110 for subsequent segmentation and measurement. Acquired volumetric data can originate from a medical imaging modality such as computed tomography (CT), magnetic resonance imaging (MRI), optical coherence tomography (OCT), angiography, or ultrasound, or an industrial scanning system used for conduit inspection.

In certain embodiments, act 404 can include segmenting acquired image data into individual branches and performing subsequent determining and calculating operations for each branch independently. Image segmentation component 208 can employ thresholding, region growing, active contour modeling, or neural network-based segmentation to delineate lumen boundaries. When a duct tree is detected, act 404 can initiate branch level processing threads, enabling parallel execution of downstream analysis steps to improve computational throughput.

In some embodiments, act 406 can include determining, by a device (for example, via diameter analysis component 114), a minimum diameter profile of the duct along its longitudinal axis. The processor 108 can compute a centerline through a lumen, generate orthogonal cross sections at discrete intervals, measure a smallest inscribed circle or equivalent radius in each cross section, and store resulting values as a longitudinal profile within memory 110.

In various embodiments, act 408 can include sampling the minimum diameters at discrete longitudinal intervals and advancing a sliding examination window in increments corresponding to a sampling interval. This step ensures uniform spatial resolution and provides a foundation for subsequent loss metric computation.

In certain embodiments, act 410 can include defining, for each longitudinal position along the duct, one or more sliding examination windows having known minimum diameters at the window's longitudinal endpoints. Window definition component 116 can define windows of varying longitudinal spans, enabling multi scale analysis of duct morphology.

In some embodiments, act 412 can include automatically calculating, by a device (for example, via narrowing calculation component 118), for each window position, a loss metric representing reduction in minimum diameter relative to an interpolation of endpoint diameters, thereby automatically detecting one or more local narrowings. A loss metric can be computed as either a maximum or average deviation between interpolated and measured diameters.

In various embodiments, act 414 can include dynamically determining a threshold value based on an average minimum diameter of neighboring duct segments. Adaptive thresholding can normalize sensitivity across varying vessel calibers or conduit sizes.

In certain embodiments, act 416 can include determining whether the computed loss metric exceeds the dynamically determined threshold. If the loss metric is not greater than the threshold, the processor 108 can advance the sliding window to the next interval. If the loss metric exceeds the threshold, the method proceeds to act 418.

In various embodiments, act 418 can include initiating a narrowing characterization and visualization subprocess, detailed in FIG. 4B, to quantify, record, and visualize each detected local narrowing. Act 418 can therefore serve as a branching point between the preliminary detection pipeline illustrated in FIG. 4A and the detailed characterization workflow illustrated in FIG. 4B.

FIG. 4B illustrates a flow diagram of an example, non-limiting narrowing characterization and visualization subprocess corresponding to act 418 of FIG. 4A, in accordance with one or more embodiments described herein. In various embodiments, the subprocess can be executed by processor 108 under control of instructions stored in memory 110 and implemented cooperatively by components 112 through 120 and optional components 204 through 210.

In certain embodiments, act 420 can include applying a filtering condition that requires each computed loss metric to exceed a relative percentage of the smaller endpoint diameter, thereby excluding tapering or bifurcation regions that are physiologic rather than pathologic. A filtering threshold can be predetermined or dynamically learned from imaging statistics.

In some embodiments, act 422 can include recording, by a device (for example, via recording component 204), positions of sliding examination windows having loss metrics that exceed the threshold and satisfy the filter condition. Each record can include positional coordinates, window width, endpoint diameters, loss values, and relevant imaging metadata. Information can be stored in memory 110 or in an external database for later retrieval, comparison, or longitudinal study.

In various embodiments, act 424 can include evaluating overlapping recorded windows by calculating an average loss within each overlapping group and selecting a representative window corresponding to the greatest average loss, thereby identifying a unique narrowing event. Overlap resolution component 206 can merge partially overlapping detections and refine the recorded coordinates of individual narrowing events.

In certain embodiments, act 426 can include determining, by a device (for example, via boundary determination component 120), boundary positions corresponding to start and end locations of each detected narrowing. Boundary determination component 120 can analyze gradients, local extrema, or inflection points of a loss metric profile to identify longitudinal limits and compute narrowing length and severity.

In some embodiments, act 428 can include quantifying narrowing severity by determining both maximum and average loss values within each representative window. These values can provide consistent, objective measures for evaluating constriction magnitude across patients, devices, or imaging sessions.

In various embodiments, act 430 can include generating, by a device (for example, visualization component 210), visualization data depicting regions of the duct having loss metrics above threshold values and displaying boundary positions of each detected narrowing. Visualization component 210 can render color-coded three-dimensional overlays, generate tabular summaries of computed parameters, or export visualization data for integration into diagnostic workstations or industrial inspection interfaces. Processor 108 can employ graphics processing unit (GPU) accelerated rendering or cloud-based visualization services to provide interactive data exploration and reporting.

In certain embodiments, the acts of FIG. 4B collectively provide a complete characterization pipeline that transforms raw volumetric image data into structured, quantitative, and interpretable results. Through integration of geometric measurement, adaptive filtering, event consolidation, and visualization, the disclosed embodiments improve the functioning of computer implemented imaging systems by enabling reproducible, objective, or automated analysis of duct morphology. These embodiments therefore provide a concrete technological improvement over conventional manual or semi-automated techniques used for duct narrowing evaluation.

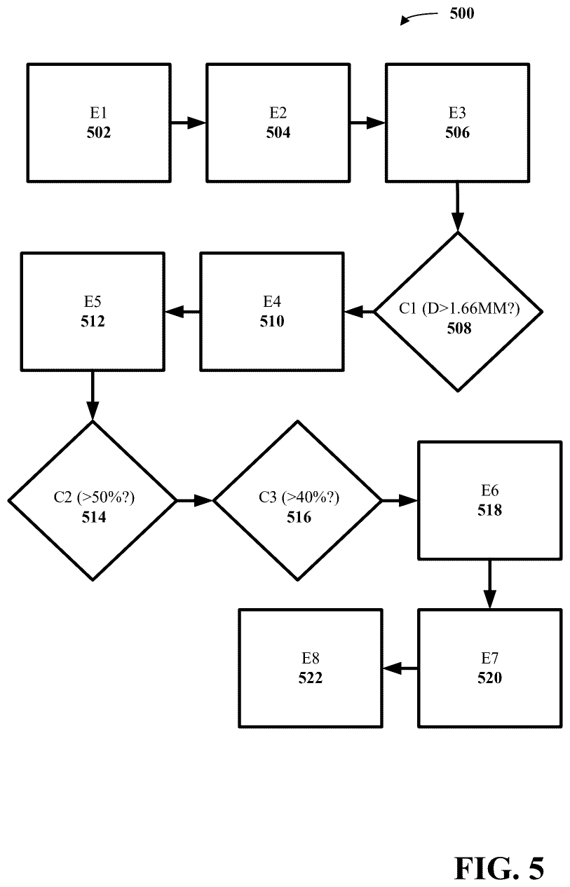

FIG. 5 illustrates a flow diagram of an example, non-limiting computer implemented method 500 that depicts an exemplary logical sequence and conditional structure used by the system for calculating and classifying local narrowings within a duct, in accordance with one or more embodiments described herein. Method 500 can be executed by a device or system such as Automated Duct Narrowing Analysis System 102 or 202, comprising at least one processor 108 operatively coupled to a non-transitory computer readable memory 110 storing computer executable instructions for implementing the acts shown in the figure.

In various embodiments, act E1 (502) can include acquiring three-dimensional image data representing at least one duct. Data can be obtained directly from an imaging modality such as computed tomography, magnetic resonance imaging, or optical coherence tomography, or retrieved from a networked imaging archive. An acquired image can optionally be processed to normalize voxel intensity, correct bias fields, or standardize coordinate frames.

In certain embodiments, act E2 (504) can include processing an acquired image data to segment a duct tree into individual branches for subsequent analysis. Image segmentation component 208 can delineate lumen boundaries using region growing, active contour modeling, or deep learning-based classification. Each branch can be isolated and stored as an independent three-dimensional volume, enabling parallelized execution of downstream acts.

In some embodiments, act E3 (506) can include determining, by a device (for example, via diameter analysis component 114), a minimum diameter profile of each duct branch along its longitudinal axis. Processor 108 can trace a centerline through a duct lumen, generate cross sectional planes orthogonal to that centerline, and compute a smallest inscribed diameter within each plane. A resulting profile can be recorded in memory 110 as an ordered sequence of minimum diameter values sampled at discrete longitudinal intervals.

In various embodiments, condition C1 (508) can determine whether a duct segment currently under analysis satisfies a minimum diameter criterion, for example greater than about 1.6 millimeters. When a condition is not met, the processor can skip subsequent analytical steps for that segment. When a condition is met, the system can proceed to act E4.

In some embodiments, act E4 (510) can include defining at least one sliding examination window along a duct for which minimum diameters at longitudinal endpoints are known. Each window can have a width between about 1.8 and 14.1 millimeters, and windows can advance in increments corresponding to the sampling interval of the minimum diameter profile. A baseline diameter between endpoints can be interpolated using a linear or spline function stored within memory 110.

In certain embodiments, act E5 (512) can include calculating, by a device (for example, via narrowing calculation component 118), for each window position, a maximum loss metric representing the reduction in minimum diameter within the window relative to an interpolated baseline. Calculated loss metrics can indicate a degree of localized narrowing, with higher values corresponding to more severe constrictions.

In various embodiments, condition C2 (514) can evaluate whether a computed loss metric exceeds a predetermined or dynamically determined threshold, such as 50 percent. If the criterion is not met, the system can continue evaluating subsequent windows. If a criterion is met, the processor proceeds to condition C3 (516).

In some embodiments, condition C3 (516) can include verifying whether a computed loss metric also exceeds a relative threshold, for example 40 percent of the smaller of two endpoint diameters. This condition can help exclude regions corresponding to normal tapering or physiological bifurcations. When both conditions C2 and C3 are satisfied, the system advances to subsequent act E6 (518).

In certain embodiments, act E6 (518) can include recording a position of each window satisfying conditions C2 and C3 as a candidate narrowing event. Recording component 204 can store a window position, width, maximum loss value, or contextual metadata such as branch identifier and imaging modality in memory 110.

In various embodiments, act E7 (520) can include evaluating overlapping windows by calculating an average loss metric within each overlapping set and selecting a representative window corresponding to a greatest average loss. Overlap resolution component 206 can merge partially overlapping detections into single consolidated narrowing events.

In some embodiments, act E8 (522) can include classifying or ranking identified narrowing events based on evaluated loss metrics to determine which events represent the most significant constrictions. Selected representative windows can be stored in structured digital form for visualization or downstream diagnostic interpretation.

In certain embodiments, the sequence shown in FIG. 5 can be implemented iteratively across multiple branches or across different window sizes to provide multi-scale analysis. Processor 108 can dynamically adjust condition thresholds based on image quality or duct caliber to ensure consistent sensitivity across a range of anatomical or structural variations. Results can then be forwarded to visualization component 210 to generate annotated three-dimensional renderings highlighting the detected narrowing events.

Accordingly, the embodiments described with respect to FIG. 5 provide a decision based computational workflow that automates detection, filtering, and classification of duct narrowings from volumetric image data. By combining deterministic measurement, adaptive thresholding, and iterative consolidation, method 500 improves the functioning of computer implemented imaging systems and provides reproducible, quantitative, and clinically interpretable results unattainable with manual or heuristic approaches.

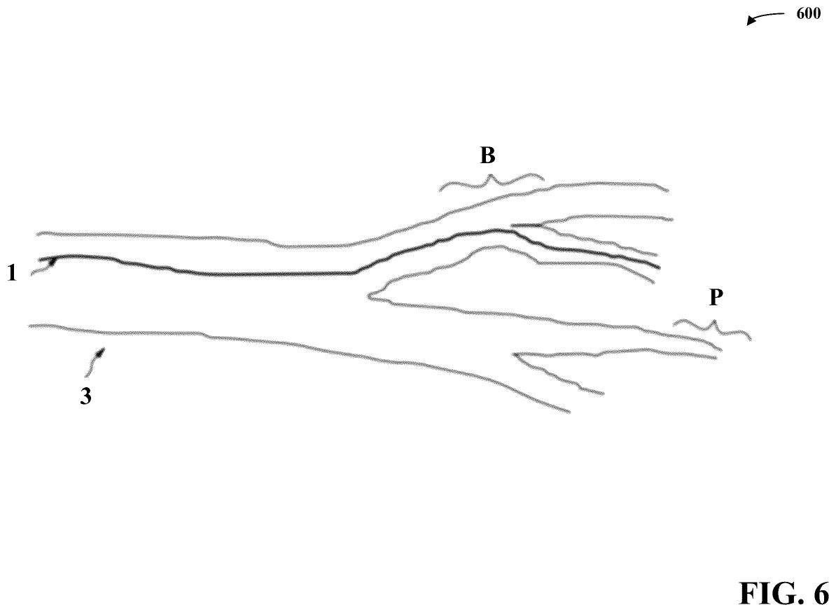

FIG. 6 illustrates an example, non-limiting schematic representation of a three-dimensional duct tree 600 in accordance with one or more embodiments described herein. In various embodiments, the duct tree 3 can represent a physiological or mechanical branching network through which a fluid or other material flows. For example, in certain embodiments, the duct tree 3 can correspond to a vascular structure such as a coronary artery tree, while in other embodiments it can represent an industrial conduit network used for fluid transport. Each individual duct 1 within the duct tree 3 can be analyzed using the methods described in connection with FIGS. 3 through 5 to determine presence, position, or extent of one or more local narrowings along its longitudinal axis.

In some embodiments, the duct tree 3 can be acquired as part of three-dimensional image data captured by an imaging modality such as computed tomography, magnetic resonance imaging, or optical coherence tomography. Image data can be processed by a system (for example, Automated Duct Narrowing Analysis System 102 or 202) to identify lumen boundaries and to segment a tree into a plurality of individual ducts or branches, each of which can be analyzed independently. As depicted schematically in FIG. 6, reference numeral 1 indicates a duct selected for analysis, which can extend from a proximal portion of the duct tree 3 toward one or more bifurcations denoted by B. Distal or terminal portions of the branches, indicated by P, can correspond to finer structures such as peripheral vessels or outflow conduits.

In various embodiments, segmentation of the duct tree 3 can be performed automatically by a computer-implemented segmentation algorithm configured to identify lumen boundaries and extract individual duct volumes. Segmentation can be guided by intensity thresholds, anatomical models, or geometric continuity constraints. The processor 108 can generate a three-dimensional model of each duct 1, determine its centerline, and prepare cross-sectional planes along a duct length to facilitate computation of a minimum diameter profile, as described previously with respect to FIGS. 4A, 4B, and 5.

In certain embodiments, a base or root portion of a duct tree 3, shown on the left side of FIG. 6, can represent a common origin of multiple branches. Bifurcation region B can mark where the duct 1 divides into secondary branches, and the peripheral region P can indicate distal sections where the diameter naturally tapers. To ensure consistent and clinically meaningful analysis, the system can apply a diameter constraint condition, for example requiring that a minimum diameter of a duct portion under evaluation be greater than a threshold value such as 1.6 millimeters, as discussed in connection with condition C1 of FIG. 5. This constraint can prevent unnecessary analysis of small distal branches where a duct size is below a relevant range for narrowing detection.

In some embodiments, the path 1 shown in FIG. 6 can correspond to a selected duct branch subjected to the full analytical process described in FIGS. 3 through 5. The path 1 can be defined along a centerline extending through the lumen of the duct, allowing measurement of cross-sectional diameters at successive longitudinal positions. Processor 108 can compute a minimum diameter profile for an entire path 1 and then apply sliding examination windows, loss metric computation, and filtering conditions described previously to detect and classify local narrowings.

In certain embodiments, the duct tree 3 depicted in FIG. 6 can be displayed within a visualization interface as part of a pre-analysis overview or post-analysis review process. Visualization component 210 can render a tree as a three-dimensional reconstruction and overlay color-coded annotations on an analyzed duct 1, a bifurcation region B, or a peripheral region P. These visual markers can guide an operator in selecting which branches to include or exclude from quantitative analysis, thereby improving workflow efficiency and analytical reproducibility.

Accordingly, FIG. 6 provides a schematic representation of a duct tree structure that may be analyzed using the methods described herein. The illustrated embodiment demonstrates how a selected duct 1 within a larger network 3 can be isolated, segmented, and processed by the system to compute quantitative metrics of local narrowing, thereby providing a reproducible and objective approach to evaluating duct morphology across complex branching systems.

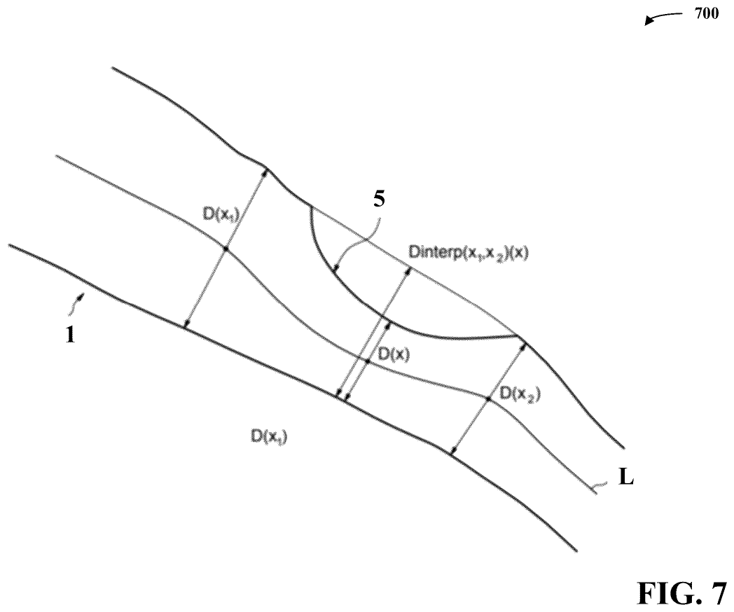

FIG. 7 illustrates an example, non-limiting schematic representation of a duct segment 700 comprising a localized narrowing in accordance with one or more embodiments described herein. In various embodiments, a duct 1 shown in FIG. 7 can correspond to a portion of a larger duct tree such as that depicted in FIG. 6 and can represent either a physiological conduit, such as a blood vessel, or a mechanical conduit in an engineered system. The figure provides a two-dimensional geometric representation of the principles used by the system to quantify diameter variation along a longitudinal path.

In some embodiments, duct 1 extends along a longitudinal axis L, which corresponds to the centerline of the lumen or internal passage. Orthogonal cross-sectional planes along axis L define local diameters of the duct at various longitudinal positions denoted by x. For instance, D(x₁) and D(x₂) represent the minimum diameters of a duct at two longitudinal endpoints x₁ and x₂ of a sliding examination window, while D(x) represents a minimum diameter at an intermediate longitudinal position within that window. The system computes these diameter values from three-dimensional image data using segmentation and centerline extraction techniques executed by processor 108 as described in earlier figures.

In various embodiments, the processor 108 can interpolate, between two endpoint diameters D(x₁) and D(x₂), a baseline or reference diameter curve, denoted schematically in the figure as Dinterp(x₁,x₂)(x). This interpolation defines an expected geometric progression of a duct diameter along a window in the absence of constriction. Interpolation can be linear, polynomial, or spline based depending on configuration parameters stored in memory 110. Interpolated diameter curve serves as a quantitative baseline for computing a loss metric at each longitudinal position x, representing deviation between an actual measured diameter D(x) and an interpolated reference diameter Dinterp(x₁,x₂)(x).

In certain embodiments, the localized narrowing 5 illustrated in FIG. 7 corresponds to a region where the measured diameter D(x) is significantly smaller than the interpolated reference diameter Dinterp(x₁,x₂)(x). The processor can determine a maximum diameter loss within a sliding examination window as the greatest difference between the interpolated and measured diameters. Magnitude of this maximum loss can indicate the severity of the narrowing, and its longitudinal location can define the point of minimum lumen size. This computational process forms the basis for acts 308 and 310 of FIG. 3 and acts E5 and E6 of FIG. 5.

In some embodiments, width of an examination window between x₁ and x₂ can range between approximately 1.8 millimeters and 14.1 millimeters, with the processor advancing the window along the duct in increments that correspond to a sampling interval of a minimum diameter profile (for example, 0.3 millimeter). Continuous repetition of this process across successive windows produces a loss metric profile along the entire duct length, allowing the system to automatically identify one or more regions corresponding to local narrowings 5.

In various embodiments, the narrowing 5 can be identified and characterized using the criteria described previously in connection with conditions C2 and C3 of FIG. 5, such that only loss metrics exceeding a relative percentage of the smaller endpoint diameter are retained. This can ensure that physiologic tapering or natural branch transitions are excluded from the detected events. Once a valid narrowing is confirmed, the system can determine boundary positions along axis L, quantify narrowing severity, and generate visualization data highlighting a region of interest within a corresponding three-dimensional model.

In certain embodiments, the geometric relationships shown in FIG. 7 can be computed and displayed by visualization component 210. The component can render overlays representing the interpolated reference curve Dinterp(x₁,x₂)(x), the actual measured diameter D(x), and the localized narrowing 5. These visualizations can be presented within an operator interface to aid clinical interpretation or engineering diagnostics and can be color-coded to indicate varying levels of constriction severity.

Accordingly, FIG. 7 provides a schematic representation of the geometric principles underlying the calculation of local narrowings within a duct. By comparing measured diameter profiles to interpolated baseline diameters within defined examination windows, the disclosed embodiments enable quantitative, reproducible, and automated detection of localized constrictions in both physiological and mechanical systems. The illustrated relationships form a geometric foundation for the computational steps of the methods described with respect to FIGS. 3 through 5.

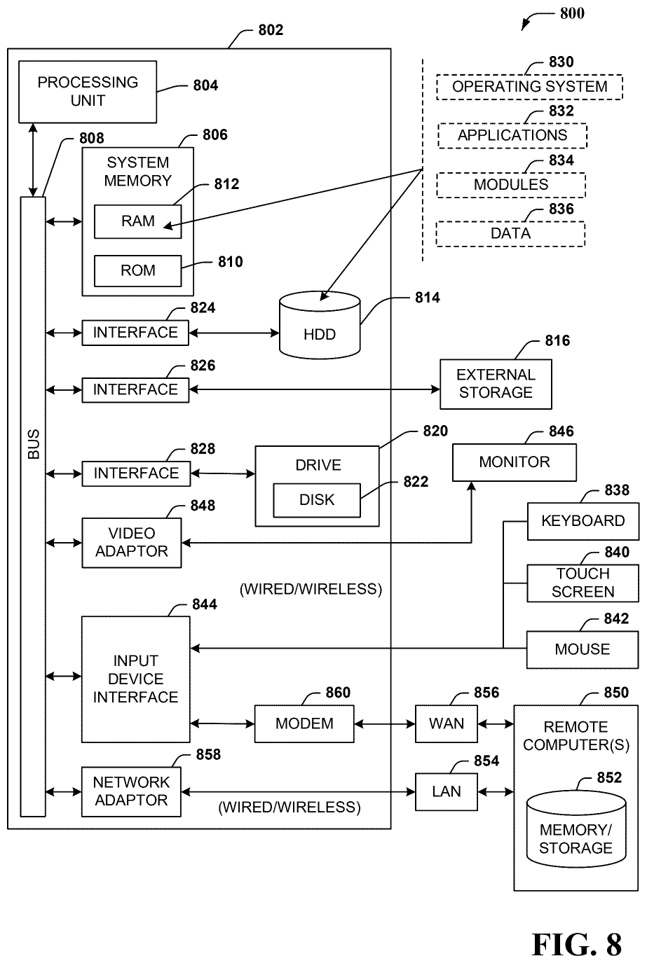

In order to provide additional context for various embodiments described herein, FIG. 8 and the following discussion are intended to provide a brief, general description of a suitable computing environment 800 in which the various embodiments of the embodiment described herein can be implemented. While the embodiments have been described above in the general context of computer executable instructions that can run on one or more computers, those skilled in the art will recognize that the embodiments can be also implemented in combination with other programming modules or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single processor or multi-processor computer systems, minicomputers, mainframe computers, Internet of Things (IoT) devices, distributed computing systems, as well as personal computers, hand held computing devices, microprocessor based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer readable storage media, machine readable storage media, or communications media, which two terms are used herein differently from one another as follows. Computer readable storage media or machine-readable storage media can be any available storage media that can be accessed by the computer and includes both volatile and nonvolatile media, removable and non-removable media. By way of example, and not limitation, computer readable storage media or machine-readable storage media can be implemented in connection with any method or technology for storage of information such as computer readable or machine-readable instructions, program modules, structured data or unstructured data.

Computer readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu ray disc (BD) or other optical disk storage, magnetic cassettes, magnetic tape, magnetic disk storage or other magnetic storage devices, solid state drives or other solid state storage devices, or other tangible or non-transitory media which can be used to store desired information. In this regard, the terms “tangible” or “non transitory” herein as applied to storage, memory or computer readable media, are to be understood to exclude only propagating transitory signals per se as modifiers and do not relinquish rights to all standard storage, memory or computer readable media that are not only propagating transitory signals per se.

Computer readable storage media can be accessed by one or more local or remote computing devices, e.g., via access requests, queries or other data retrieval protocols, for a variety of operations with respect to the information stored by the medium.

Communications media typically embody computer readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct wired connection, and wireless media such as acoustic, RF, infrared and other wireless media.

With reference again to FIG. 8, the example environment 800 for implementing various embodiments of the aspects described herein includes a computer 802, the computer 802 including a processing unit 804, a system memory 806 and a system bus 808. The system bus 808 couples'system components including, but not limited to, the system memory 806 to the processing unit 804. The processing unit 804 can be any of various commercially available processors. Dual microprocessors and other multi-processor architectures can also be employed as the processing unit 804.

The system bus 808 can be any of several types of bus structure that can further interconnect to a memory bus (with or without a memory controller), a peripheral bus, and a local bus using any of a variety of commercially available bus architectures. The system memory 806 includes ROM 810 and RAM 812. A basic input/output system (BIOS) can be stored in a nonvolatile memory such as ROM, erasable programmable read only memory (EPROM), EEPROM, which BIOS contains the basic routines that help to transfer information between elements within the computer 802, such as during startup. The RAM 812 can also include a high-speed RAM such as static RAM for caching data.

The computer 802 further includes an internal hard disk drive (HDD) 814 (e.g., EIDE, SATA), one or more external storage devices 816 (e.g., a magnetic floppy disk drive (FDD) 816, a memory stick or flash drive reader, a memory card reader, etc.) and a drive 820, e.g., such as a solid state drive, an optical disk drive, which can read or write from a disk 822, such as a CD ROM disc, a DVD, a BD, etc. Alternatively, where a solid-state drive is involved, disk 822 would not be included, unless separate. While the internal HDD 814 is illustrated as located within the computer 802, the internal HDD 814 can also be configured for external use in a suitable chassis (not shown). Additionally, while not shown in environment 800, a solid-state drive (SSD) could be used in addition to, or in place of, an HDD 814. The HDD 814, external storage device(s) 816 and drive 820 can be connected to the system bus 808 by an HDD interface 824, an external storage interface 826 and a drive interface 828, respectively. The interface 824 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer readable storage media provide nonvolatile storage of data, data structures, computer executable instructions, and so forth. For the computer 802, the drives and storage media accommodate the storage of any data in a suitable digital format. Although the description of computer readable storage media above refers to respective types of storage devices, it should be appreciated by those skilled in the art that other types of storage media which are readable by a computer, whether presently existing or developed in the future, could also be used in the example operating environment, and further, that any such storage media can contain computer executable instructions for performing the methods described herein.

A number of program modules can be stored in the drives and RAM 812, including an operating system 830, one or more application programs 832, other program modules 834 and program data 836. All or portions of the operating system, applications, modules, or data can also be cached in the RAM 812. The systems and methods described herein can be implemented utilizing various commercially available operating systems or combinations of operating systems.

Computer 802 can optionally comprise emulation technologies. For example, a hypervisor (not shown) or other intermediary can emulate a hardware environment for operating system 830, and the emulated hardware can optionally be different from the hardware illustrated in FIG. 8. In such an embodiment, operating system 830 can comprise one virtual machine (VM) of multiple VMs hosted at computer 802. Furthermore, operating system 830 can provide runtime environments, such as the Java runtime environment or the .NET framework, for applications 832. Runtime environments are consistent execution environments that allow applications 832 to run on any operating system that includes the runtime environment. Similarly, operating system 830 can support containers, and applications 832 can be in the form of containers, which are lightweight, standalone, executable packages of software that include, e.g., code, runtime, system tools, system libraries, and settings for an application.

Further, computer 802 can be enabled with a security module, such as a trusted processing module (TPM). For instance, with a TPM, boot components hash next in time boot components, and wait for a match of results to secured values, before loading a next boot component. This process can take place at any layer in the code execution stack of computer 802, e.g., applied at the application execution level or at the operating system (OS) kernel level, thereby enabling security at any level of code execution.

A user can enter commands and information into the computer 802 through one or more wired/wireless input devices, e.g., a keyboard 838, a touch screen 840, and a pointing device, such as a mouse 842. Other input devices (not shown) can include a microphone, an infrared (IR) remote control, a radio frequency (RF) remote control, or other remote control, a joystick, a virtual reality controller or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 804 through an input device interface 844 that can be coupled to the system bus 808, but can be connected by other interfaces, such as a parallel port, an IEEE 1394 serial port, a game port, a USB port, an IR interface, a BLUETOOTH® interface, etc.

A monitor 846 or other type of display device can also be connected to the system bus 808 via an interface, such as a video adapter 848. In addition to the monitor 846, a computer typically includes other peripheral output devices (not shown), such as speakers, printers, etc.

The computer 802 can operate in a networked environment using logical connections via wired or wireless communications to one or more remote computers, such as a remote computer(s) 850. The remote computer(s) 850 can be a workstation, a server computer, a router, a personal computer, portable computer, microprocessor based entertainment appliance, a peer device or other common network node, and typically includes many or all of the elements described relative to the computer 802, although, for purposes of brevity, only a memory/storage device 852 is illustrated. The logical connections depicted include wired/wireless connectivity to a local area network (LAN) 854 or larger networks, e.g., a wide area network (WAN) 856. Such LAN and WAN networking environments are commonplace in offices and companies, and facilitate enterprise-wide computer networks, such as intranets, all of which can connect to a global communications network, e.g., the Internet.

When used in a LAN networking environment, the computer 802 can be connected to the local network 854 through a wired or wireless communication network interface or adapter 858. The adapter 858 can facilitate wired or wireless communication to the LAN 854, which can also include a wireless access point (AP) disposed thereon for communicating with the adapter 858 in a wireless mode.

When used in a WAN networking environment, the computer 802 can include a modem 860 or can be connected to a communications server on the WAN 856 via other means for establishing communications over the WAN 856, such as by way of the Internet. The modem 860, which can be internal or external and a wired or wireless device, can be connected to the system bus 808 via the input device interface 844. In a networked environment, program modules depicted relative to the computer 802 or portions thereof can be stored in the remote memory/storage device 852. It will be appreciated that the network connections shown are example and other means of establishing a communications link between the computers can be used.

When used in either a LAN or WAN networking environment, the computer 802 can access cloud storage systems or other network based storage systems in addition to, or in place of, external storage devices 816 as described above, such as but not limited to a network virtual machine providing one or more aspects of storage or processing of information. Generally, a connection between the computer 802 and a cloud storage system can be established over a LAN 854 or WAN 856 e.g., by the adapter 858 or modem 860, respectively. Upon connecting the computer 802 to an associated cloud storage system, the external storage interface 826 can, with the aid of the adapter 858 or modem 860, manage storage provided by the cloud storage system as it would other types of external storage. For instance, the external storage interface 826 can be configured to provide access to cloud storage sources as if those sources were physically connected to the computer 802.

The computer 802 can be operable to communicate with any wireless devices or entities operatively disposed in wireless communication, e.g., a printer, scanner, desktop or portable computer, portable data assistant, communications satellite, any piece of equipment or location associated with a wirelessly detectable tag (e.g., a kiosk, news stand, store shelf, etc.), and telephone. This can include Wireless Fidelity (Wi Fi) and BLUETOOTH® wireless technologies. Thus, the communication can be a predefined structure as with a conventional network or simply an ad hoc communication between at least two devices.

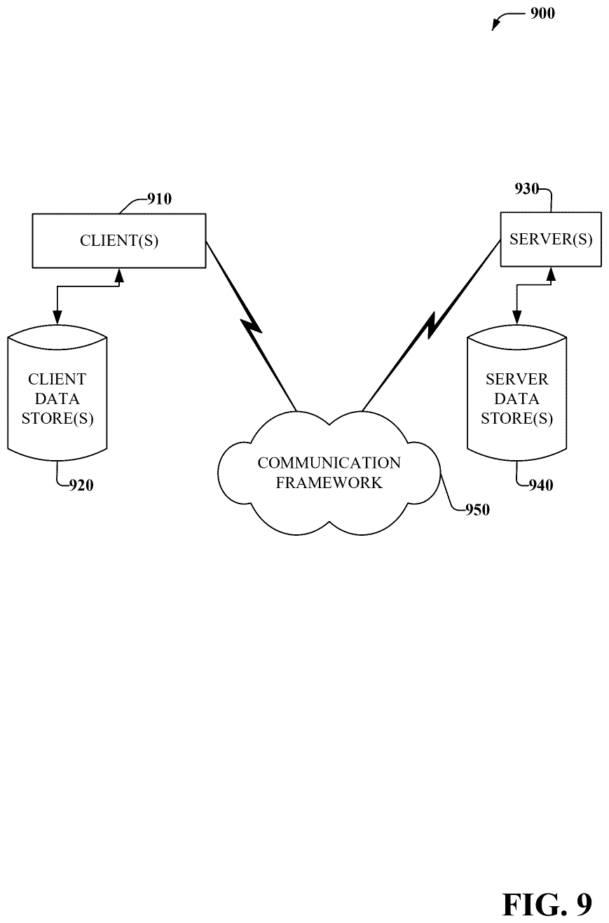

FIG. 9 is a schematic block diagram of a sample computing environment 900 with which the disclosed subject matter can interact. The sample computing environment 900 includes one or more client(s) 910. The client(s) 910 can be hardware or software (e.g., threads, processes, computing devices). The sample computing environment 900 also includes one or more server(s) 930. The server(s) 930 can also be hardware or software (e.g., threads, processes, computing devices). The servers 930 can house threads to perform transformations by employing one or more embodiments as described herein, for example. One possible communication between a client 910 and a server 930 can be in the form of a data packet adapted to be transmitted between two or more computer processes. The sample computing environment 900 includes a communication framework 950 that can be employed to facilitate communications between the client(s) 910 and the server(s) 930. The client(s) 910 are operably connected to one or more client data store(s) 920 that can be employed to store information local to the client(s) 910. Similarly, the server(s) 930 are operably connected to one or more server data store(s) 940 that can be employed to store information local to the servers 930.

Various embodiments can be a system, a method, an apparatus or a computer program product at any possible technical detail level of integration. The computer program product can include a computer readable storage medium (or media) having computer readable program instructions thereon for causing a processor to carry out aspects of various embodiments. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read only memory (ROM), an erasable programmable read only memory (EPROM or Flash memory), a static random access memory (SRAM), a portable compact disc read only memory (CD ROM), a digital versatile disk (DVD), a memory stick, a floppy disk, a mechanically encoded device such as punch cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of various embodiments can be assembler instructions, instruction set architecture (ISA) instructions, machine instructions, machine dependent instructions, microcode, firmware instructions, state setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a standalone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field programmable gate arrays (FPGA), or programmable logic arrays (PLA) can execute the computer readable program instructions by utilizing state information of the computer readable program instructions to personalize the electronic circuitry, in order to perform various aspects.

Various aspects are described herein with reference to flowchart illustrations or block diagrams of methods, apparatus (systems), and computer program products according to various embodiments. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus, or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart or block diagram block or blocks.

The flowcharts and block diagrams in the Figures illustrate the architecture, functionality, and operation of possible implementations of systems, methods, and computer program products according to various embodiments. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer executable instructions of a computer program product that runs on a computer or computers, those skilled in the art will recognize that this disclosure also can or can be implemented in combination with other programming modules. Generally, program modules include routines, programs, components, data structures, etc. that perform particular tasks or implement particular abstract data types. Moreover, those skilled in the art will appreciate that various aspects can be practiced with other computer system configurations, including single processor or multiprocessor computer systems, mini computing devices, mainframe computers, as well as computers, hand held computing devices (e.g., PDA, phone), microprocessor based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to or can include a computer related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, or a computer. By way of illustration, both an application running on a server and the server can be a component. One or more components can reside within a process or thread of execution, and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system, or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter disclosed herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

The disclosure herein describes non-limiting examples. For ease of description or explanation, various portions of the herein disclosure utilize the term “each,” “every,” or “all” when discussing various examples. Such usages of the term “each,” “every,” or “all” are non-limiting. In other words, when the herein disclosure provides a description that is applied to “each,” “every,” or “all” of some particular object or component, it should be understood that this is a non-limiting example, and it should be further understood that, in various other examples, it can be the case that such description applies to fewer than “each,” “every,” or “all” of that particular object or component.

As it is employed in the subject specification, the term “processor” can refer to substantially any computing processing unit or device comprising, but not limited to, single core processors; single processors with software multithread execution capability; multi core processors; multi core processors with software multithread execution capability; multi core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano scale architectures such as, but not limited to, molecular and quantum dot-based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random-access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer implemented methods herein are intended to include, without being limited to including, these and any other suitable types of memory.

What has been described above include mere examples of systems and computer implemented methods. It is, of course, not possible to describe every conceivable combination of components or computer implemented methods for purposes of describing this disclosure, but many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a processor that executes computer-executable components stored in a non-transitory computer-readable memory, wherein the computer-executable components comprise:
a data access component that accesses three-dimensional image data representing at least one duct;
a diameter analysis component that determines a minimum diameter profile of the duct along a longitudinal axis of the duct;
a window definition component that defines, for each longitudinal position along the duct, a sliding examination window having known minimum diameters at longitudinal endpoints of a window;
a narrowing calculation component that automatically calculates, for each position of a sliding examination window, a loss metric representing a reduction in minimum diameter relative to an interpolation of diameters at the window's longitudinal endpoints, the loss metric being indicative of one or more local narrowings of the duct; and
a boundary determination component that, for each detected local narrowing, determines boundary positions corresponding to start and end locations of the narrowing based on variations in the loss metric along the duct, and outputs the boundary positions for use in at least one of generating visualization data or generating a narrowing characterization result.

2. The system of claim 1, further comprising a recording component that records a position of the sliding examination window in response to the loss metric exceeding a threshold value indicative of a local narrowing of the duct.

3. The system of claim 2, further comprising an overlap resolution component that determines, for overlapping sliding examination windows, an average loss metric within each window and selects a representative window corresponding to a greatest average loss, wherein the representative window identifies a unique narrowing event and refines the boundary positions determined by the boundary determination component.

4. The system of claim 1, further comprising an image segmentation component that segments image data representing the at least one duct into individual branches and to cause the diameter analysis component and the narrowing calculation component to operate on each branch independently.

5. The system of claim 1, wherein the diameter analysis component samples minimum diameters at discrete longitudinal intervals and the window definition component advances the sliding examination window along the duct in increments that correspond to the discrete sampling intervals.

6. The system of claim 1, wherein the window definition component, defines a plurality of sliding examination windows having distinct longitudinal spans to enable multi-scale analysis of local duct geometry.

7. The system of claim 2, wherein the narrowing calculation component applies a filter that requires the loss metric within the sliding examination window to exceed a relative percentage of a smaller of the endpoint minimum diameters, wherein application of the filter excludes tapering or bifurcation regions.

8. The system of claim 1, further comprising a visualization component that generates display data depicting regions of the duct having loss metrics exceeding the threshold value and highlighting boundary positions of each detected local narrowing.

9. The system of claim 1, wherein the diameter analysis component limits analysis to duct segments having minimum diameters greater than a predetermined threshold.

10. The system of claim 1, wherein the duct comprises a physiological vessel including at least one of a coronary artery, a carotid artery, a renal artery, or a bile duct, and wherein the system operates on three-dimensional image data acquired by a medical imaging modality.

11. A computer-implemented method for calculating local narrowings in a duct, a method comprising:
acquiring three-dimensional image data representing at least one duct;
determining a minimum diameter profile of the duct along a longitudinal axis of the duct;
defining, for each longitudinal position along the duct, a sliding examination window having known minimum diameters at longitudinal endpoints of the window;
automatically calculating, for each position of a sliding examination window, a loss metric representing a reduction in minimum diameter relative to an interpolation of diameters at the window's longitudinal endpoints, the loss metric being indicative of one or more local narrowings of the duct; and
determining, for each detected local narrowing, boundary positions corresponding to start and end locations of the narrowing based on variations in the loss metric along the duct and output the boundary positions for use in at least one of visualization or a narrowing characterization output.

12. The method of claim 11, further comprising recording a position of the sliding examination window in response to the loss metric exceeding a threshold value indicative of a local narrowing of the duct.

13. The method of claim 12, further comprising evaluating, for overlapping sliding examination windows, an average loss metric within each window and selecting a representative window corresponding to a greatest average loss, wherein the representative window identifies a unique narrowing event and refines a determined boundary position.

14. The method of claim 11, further comprising segmenting image data representing the at least one duct into individual branches and performing the determining and automatically calculating for each branch independently.

15. The method of claim 11, wherein determining the minimum diameter profile comprises sampling minimum diameters at discrete longitudinal intervals and advancing the sliding examination window along the duct in increments that correspond to the discrete sampling intervals.

16. The method of claim 11, further comprising applying a filter that requires the loss metric within the sliding examination window to exceed a relative percentage of a smaller of the endpoint minimum diameters, wherein application of the filter excludes tapering or bifurcation regions.

17. The method of claim 11, further comprising generating visualization data depicting regions of the duct having loss metrics exceeding the threshold value and displaying boundary positions of each detected local narrowing.

18. The method of claim 11, wherein the threshold value is dynamically determined based on an average minimum diameter of neighboring duct segments.

19. The method of claim 11, wherein automatically calculating the loss metric further comprises determining both a maximum and an average loss value within each sliding examination window to quantify narrowing severity across multiple metrics.

20. A computer program product comprising a non-transitory computer-readable memory having program instructions embodied therewith, the program instructions executable by a processor to cause the processor to:
acquire three-dimensional image data representing at least one duct;
determine a minimum diameter profile of a duct along a longitudinal axis of the duct based on three-dimensional image data;
define, for each longitudinal position along the duct, a sliding examination window having known minimum diameters at longitudinal endpoints of the window;
automatically calculate, for each position of a sliding examination window, a loss metric representing a reduction in minimum diameter relative to an interpolation of diameters at the window's longitudinal endpoints, the loss metric being indicative of one or more local narrowings of the duct; and
determine, for each detected local narrowing, boundary positions corresponding to start and end locations of the narrowing based on variations in the loss metric along the duct and output the boundary positions for use in at least one of visualization or a narrowing characterization output.
